(19) United States
(12) Patent Application Publication
(10) Pub. No.: US 2022/0221810 A1
(43) Pub. Date: Jul. 14, 2022

(54) DEVELOPING CARTRIDGE

(71) Applicant: JIANGXI YIBO E-TECH CO. LTD., Xinyu (CN)

(72) Inventor: Shiping Ao, Xinyu (CN)

(21) Appl. No.: 17/569,637

(22) Filed: Jan. 6, 2022

(30) Foreign Application Priority Data
Jan. 8, 2021 (CN) 202120047291.5

(51) Int. Cl. G03G 15/08

(52) U.S. Cl. CPC G03G 15/0875

(57) ABSTRACT

The present disclosure relates to a developing cartridge, which can be detachably installed in an electronic imaging device, comprising: a housing having a developer accommodating portion capable of accommodating a developer; a developing roller, which is provided on a lower end side of the housing, is rotatably supported by the housing, and can carry the developer on its outer surface; and a handle provided on an upper end side of the housing opposite to the lower end side; wherein the handle comprises a grasping portion, the grasping portion has an upper plate and a lower plate, an accommodating portion is provided between the lower plate and the housing, and a rib connecting the upper plate and the lower plate is provided between the upper plate and the lower plate. The technical problem in the prior art that the elastic plate in the handle is easily damaged is solved.

### TECHNICAL FIELD

The present disclosure relates to a developing cartridge, which can be detachably installed in an electronic imaging device.

### BACKGROUND

An electronic imaging device is a device that forms an image on a recording material through the principle of electrophotographic imaging, for example, an electrophotographic copier, a laser printer, an electrophotographic printer (such as a laser printer and an LED printer, etc.), a fax machine, and a word processor. The imaging device usually includes a developing cartridge and a drum cartridge. The developing cartridge supplies a developer to the drum cartridge that has been formed with an electrostatic latent image. A visible developer image corresponding to the electrostatic latent image is formed on a photosensitive drum of the drum cartridge. Then, the developer image is transferred onto a recording medium through transferring, and finally the developer image is fixed onto the recording medium through fixing. Finally, the recording medium is discharged from an image forming apparatus to complete the printing operation.

Generally, the developing cartridge includes: a housing, which can store developer; a developing roller, which is supported at both ends of the housing; and a layer thickness regulating member, which controls the thickness of the developer on the developing roller. The layer thickness regulating member includes a blade, and the blade is in contact with the developing roller and controls the thickness of the developer on the developing roller. During the working process of the developing cartridge, the layer thickness regulating member needs to be stably installed on the housing, so that the thickness of the developer on the developing roller can always be maintained at a uniform thickness, thereby ensuring the printing quality of the imaging apparatus.

As shown in FIG. 1, a developing cartridge is disclosed in the prior art. It includes a housing 61 for storing a developer, and a handle at an upper end of the housing. The handle includes an elastic plate 70, a bottom plate 67, and a connecting wall 68 for connecting the elastic plate 70 and the housing 61. However, in actual use, if a user exerts too much force, it is easy to squeeze the elastic plate 70 excessively, resulting in the elastic plate not recovering from deformation or directly fracturing the elastic plate 70.

### SUMMARY

In order to solve the above problem in the prior art that the elastic plate in the handle is easily damaged, the developing cartridge of the present disclosure adopts the following technical solution:

A developing cartridge, which can be detachably installed in an electronic imaging device, comprising:

a housing having a developer accommodating portion capable of accommodating developer;

a developing roller, which is provided on a lower end side of the housing, is rotatably supported by the housing, and can carry the developer on its outer surface; and

a handle provided on an upper end side of the housing opposite to the lower end side;

wherein the handle comprises a grasping portion, the grasping portion has an upper plate and a lower plate, an accommodating portion is provided between the lower plate and the housing, and a rib connecting the upper plate and the lower plate is provided between the upper plate and the lower plate.

Preferably, the upper plate, the lower plate, and the accommodating portion are sequentially arranged in an up and down direction.

Preferably, a plurality of ribs are provided between the upper plate and the lower plate, and a gap portion is provided between the plurality of ribs.

Preferably, the rib is provided at an approximately central position of the upper plate and the lower plate in a length direction.

Preferably, a pair of connecting walls is provided between the upper plate and the housing, and the rib is provided between the pair of connecting walls.

Preferably, the upper plate and the lower plate are arranged in parallel, and the rib is arranged perpendicular to the upper plate and the lower plate.

Preferably, an upper end surface of the housing is flush with an upper end surface of the lower plate.

Preferably, a pair of connecting walls is provided between the upper plate and the housing, the connecting walls protrude outside the housing, and the rib is provided between the pair of connecting walls.

After the above technical solution is adopted, the deformation of the upper plate can be effectively prevented by adding the rib between the upper plate and the lower plate. The technical problem of fracturing the upper plate caused during the process of grasping the developing cartridge is avoided. The structure is simple and stable, and it is easy for users to operate.

### BRIEF DESCRIPTION OF FIGURES

FIG. 1 is a schematic diagram of a three-dimensional structure of an existing developing cartridge;

FIG. 2 is a schematic diagram of a three-dimensional structure of a developing cartridge according to an embodiment of the present disclosure viewed from a first view angle;

FIG. 3 is a schematic diagram of the three-dimensional structure of the developing cartridge according to an embodiment of the present disclosure viewed from a second view angle; and

FIG. 4 is a schematic diagram of the three-dimensional structure of the developing cartridge according to an embodiment of the present disclosure viewed from a third view angle.

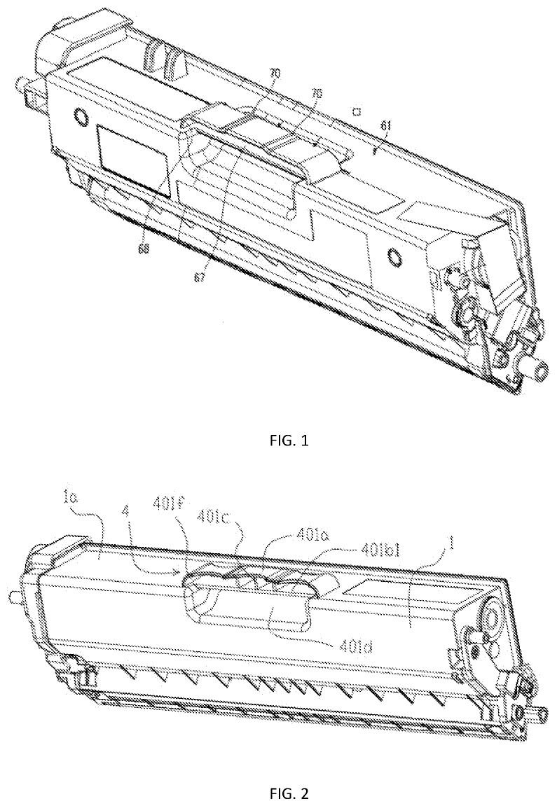

### DETAILED DESCRIPTION

In order to make the objectives, technical solutions and technical effects of the embodiments of the present disclosure clearer, the technical solution of the developing cartridge of the present disclosure will be described clearly and completely in conjunction with the accompanying drawings.

In the following description, an extending direction of a rotation axis of a developing roller is a length direction of a developing cartridge.

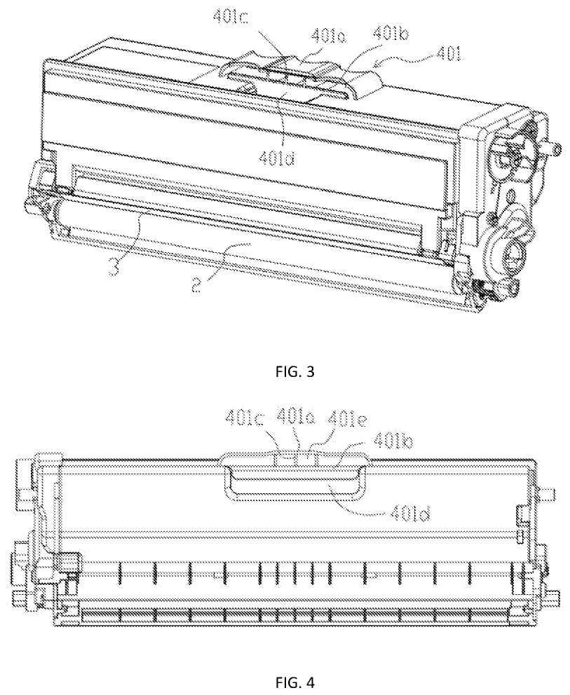

As shown in FIGS. 2 to 4, which are schematic diagrams of a three-dimensional structure of a developing cartridge according to an embodiment of the present disclosure, the developing cartridge includes: a housing 1 having a developer accommodating portion capable of accommodating a developer; and a developing roller 2, which can carry the developer on its outer surface, and is rotatably supported by the housing 1; a doctor blade 3, which regulates the thickness of the developer on the outer surface of the developing roller 2, and at the same time causes the developer to be frictionally charged with the toner discharging blade and the developing roller; and a handle 4 provided at an upper end of the housing 1, wherein the developing roller 2 is provided at a lower end of the housing 1, and the upper end and the lower end of the housing 1 are arranged opposite to each other. The handle 4 has a grasping portion 401, and the grasping portion 401 has an upper and lower layer structure. Specifically, it includes an upper plate 401a and a lower plate 401b. A rib 401c is connected between the upper plate 401a and the lower plate 401b, and used to support the upper plate 401a and the lower plate 401b. An accommodating portion 401d capable of accommodating a user's fingers is provided between the lower plate 401 and the housing 1. Preferably, the upper plate 401a and the lower plate 401b are arranged in parallel, the rib 401c is arranged perpendicular to the upper plate 401a and the lower plate 401b, and the lower plate 401b is parallel to an upper end surface 1a of the housing 1. Further, the rib 401c is provided at an approximately central position of the upper plate 401a and the lower plate 401b in a length direction.

Further, the housing 1 has an upper end surface 1a, and the upper end surface 1a of the housing 1 is flush with an upper end surface 401b1 of the lower plate 401b. This design can simplify the structure of the injection mold, and avoid the complicated design of the mold structure caused by the step structure provided between the upper end surface 1a and the upper end surface 401b1 of the lower plate 401b. Preferably, the upper plate 401a, the lower plate 401b, and the accommodating portion 401d are sequentially arranged in an up and down direction. An accommodating portion 401d is provided between the lower plate 401b and the housing 1, and the accommodating portion 401d is convenient for the user's fingers to be accommodated. A pair of connecting walls 401f is provided between the upper plate 401a and the housing 1 and protrudes outside the housing 1. In addition, the rib 401c is provided between the pair of connecting walls 401f, which can facilitate the user's grasping. Moreover, it makes the marking of the handle obvious, which is convenient for the user to operate. Further, there are a plurality of ribs 401c between the upper plate 401a and the lower plate 401b, preferably three, to further strengthen the connection strength between the upper plate 401a and the lower plate 401b. A gap portion 401e is also provided between the plurality of ribs 401c.

In the present disclosure, the deformation of the upper plate can be effectively prevented by adding the rib between the upper plate and the lower plate. The technical problem of fracturing the upper plate caused during the process of grasping the developing cartridge is avoided. The structure is simple and stable, and it is easy for users to operate.

The above embodiments are only used to illustrate the technical solutions of the present disclosure, and are not intended to limit the present disclosure. Although the present disclosure has been described in detail with reference to the foregoing embodiments, it should be understood by those of ordinary skill in the art that it is still possible to make modifications of the technical solutions described in the foregoing embodiments or equivalent replacements of some technical features therein. However, these modifications or replacements do not cause the essence of corresponding technical solutions to deviate from the spirit and scope of the technical solutions of the embodiments of the present disclosure.

What is claimed is:

1. A developing cartridge comprising:
a housing with a developer accommodating portion configured to accommodate developer;
a developing roller on a lower end side of the housing, and rotatably supported by the housing; and
a handle on an upper end side of the housing opposite to the lower end side;
wherein the handle comprises a grasping portion;
wherein the grasping portion comprises an upper plate, a lower plate, an accommodating portion between the lower plate and the housing, and a rib connecting the upper plate and the lower plate.

2. The developing cartridge according to claim 1, wherein the upper plate and the accommodating portion are on opposite sides of the lower plate.

3. The developing cartridge according to claim 1, wherein the grasping portion further comprises a plurality of the ribs connecting the upper plate and the lower plate, and wherein the plurality of the ribs are spaced apart by a gap portion.

4. The developing cartridge according to claim 1, wherein the rib is provided at an approximately central position of the upper plate and the lower plate in a length direction.

5. The developing cartridge according to claim 1, further comprising a pair of connecting walls between the upper plate and the housing, wherein the rib is between the pair of connecting walls.

6. The developing cartridge according to claim 1, wherein the upper plate and the lower plate are arranged in parallel, and the rib is perpendicular to the upper plate and the lower plate.

7. The developing cartridge according to claim 1, wherein an upper end surface of the housing is flush with an upper end surface of the lower plate.

8. The developing cartridge according to claim 1, further comprising a pair of connecting walls between the upper plate and the housing, wherein the connecting walls protrude outside the housing, and wherein the rib is between the pair of connecting walls.
